(19) United States
(12) Patent Application Publication
(10) Pub. No.: US 2005/0170054 A1
(43) Pub. Date: Aug. 4, 2005

(54) Method and apparatus for producing frozen desserts

(75) Inventors: Jennifer Czark, Watertown, MA (US); Richard G. McDuffie, Worcester, MA (US); Wayne Schrottman, Milford, MA (US)

Correspondence Address: HOFFMANN & BARON, LLP, 6900 JERICHO TURNPIKE, SYOSSET, NY, 11791, US

(73) Assignee: The Holmes Group, Inc.

(21) Appl. No.: 10/768,578

(22) Filed: Jan. 30, 2004

(51) Int. Cl. A23P 1/00

(52) U.S. Cl. 426/518

(57) ABSTRACT

A method and apparatus are provided for producing blended dessert products. The apparatus includes a base, a container removably mounted to the base, a cutting member for slicing, chopping and/or grating food products, and a mixing blade in the container for blending the food products once they have been sliced, chopped or grated. In accordance with the method, a frozen food product such as ice cream and a second food product such as cookies, candy and/or nuts are fed to a cutting member where they are sliced, grated and/or chopped and them caused to drop into a container. The food products are then blended within the container by a mixing blade, preferably producing a dessert product having the consistency of soft ice cream that contains chunks and/or slices of other food products.

### BACKGROUND OF THE INVENTION

1. Field of the Invention

The field of the invention relates to methods and devices for blending frozen dessert products such as ice cream with other food products such as cookies, nuts, and/or candy.

2. Brief Description of the Related Art

Various devices have been developed for the purpose of combining ice cream with other food products. A fairly common approach for blending such products has been to use an auger that extends into a generally funnel-shaped container. Hard ice cream and/or other ingredients are inserted into the container, which are then blended therein by the auger. The container has a bottom opening through which the blended products are dispensed. In addition to blending and causing the resulting dessert product to be urged towards the opening, this type of assembly further causes the relatively hard frozen dairy or dessert product introduced into the container to be softened. U.S. Pat. Nos. 2,626,133, 3,352,543, 4,708,489, 4,755,060 and 4,828,398 disclose various dessert makers of this general type. Containers of both cylindrical and conical configuration are disclosed in U.S. Pat. No. 3,352,543.

Another auger-type dessert maker is disclosed in Publication No. U.S. 2003/0031083 A1. The auger is oriented in a horizontal rather than a vertical direction, and is positioned within a horizontal nozzle having an output orifice. A vertical hopper is mounted to the nozzle, and is used to receive ingredients such as hard ice cream. A piston and rod assembly in the hopper is used to urge the ingredients into the nozzle where they will be blended and then extruded through the output orifice.

An apparatus for making soft ice drinks is disclosed in U.S. Pat. No. 4,745,773. The apparatus includes a reservoir for receiving ice cubes, a slit in which a shaving blade is positioned, a container, rotary blades in the container, and a discharge chute for conveying shaved ice from the shaving blade to the container. Two electric motors are provided, one for driving the ice shaving mechanism and the other for driving the mixing assembly.

U.K. Patent Application GB 2136103A discloses an ice cream machine including a blender and a mixing chamber. The blender is used for processing ingredients prior to their introduction to the mixing chamber. A single motor is employed for operating the blender and the mixing assembly.

### SUMMARY OF THE INVENTION

Dessert makers that employ augers to blend and dispense frozen food products and blends thereof are not ideal for many situations. Mixing devices that are designed to operate at high speed also do not allow the production of certain dessert products. A method and apparatus are provided that offer greater convenience for users who may prefer to serve a frozen dessert product at a dining table, outdoors, or in any location where the dessert maker cannot be readily operated. Moreover, a blended dessert product having desirable taste and texture can be prepared in accordance with the invention.

A method for providing a soft, frozen dessert product employs an assembly including a receptacle, a cutting member, a container and a mixing blade in the container. A frozen food product such as ice cream or ice milk is fed with a second food product into the receptacle. The frozen food product may be relatively hard. The second food product is different in texture from the frozen food product. The two substantially unmixed food products are urged into the cutting member. The speed at which the unmixed food products move with respect to the cutting member, set by the user or manufacturer, is such that the frozen food product and the second food product are grated, chopped and/or sliced. The chopped/sliced food products are then introduced into the container where they are blended by the mixing blade. The speed at which the mixing blade is operable is such that the products are blended to form a dessert product of desired consistency.

The above method is conducive to blending frozen food products with other food products such as candy, nuts, fruit or cookies. The speed at which they move past the cutting member(s) is accordingly such that the resulting product is not mushy and the tastes and/or textures of the products are each individually discernable. Rotation of the cutting member and mixing blade at appropriate speeds is disclosed as a way to process the food products so that they will have the desired consistency and texture. The two or more food products are blended in the container, preferably resulting in a product in which the second food product(s) is blended in a matrix of relatively soft frozen food product(s) with the taste and texture of the second food product being maintained.

An apparatus for converting hard frozen food products into softer products and blending such products is also provided. The apparatus includes a base and a container removably mounted to the base. A feed vessel is provided as a receptacle for the food products to be processed in the apparatus. A cutting member is provided for chopping, grating and/or slicing the food products prior to their being deposited in the container. The cutting member includes one or more cutting edges and one or more openings adjoining the cutting edges(s). The container includes a mixing blade for blending the chopped/sliced food products. A low speed, high torque electric motor (or motors) is preferably employed for causing relative movement between the cutting member and the food products introduced into the feed vessel and for rotating the mixing blade. The apparatus is designed such that the blending and mixing speeds are within desired ranges that will produce a dessert product of desired consistency and texture.

### BRIEF DESCRIPTION OF THE DRAWINGS

FIG. 1 is a top perspective view of a dessert making apparatus in accordance with the invention;

FIG. 2A is an exploded, perspective view thereof;

FIG. 2B is an enlarged, sectional view of a portion of a cutting blade employed in the apparatus;

FIG. 3 is a partially exploded, perspective view thereof;

FIG. 4 is a partially sectional, elevation view thereof;

FIG. 5 is a partially sectional, elevation view thereof showing a step in the method of operation of the apparatus;

FIG. 6 is a partially sectional, elevation view showing a further step in the method of operation of the apparatus;

FIG. 7 is a partially sectional, elevation view further showing the method of operation of the apparatus;

FIG. 8 is a partially sectional, elevation view of a second embodiment of a dessert making apparatus; and

FIG. 9 is a partially sectional, elevation view of a third embodiment of a dessert making apparatus.

### DETAILED DESCRIPTION OF THE INVENTION

A method and apparatus for producing desserts is provided. While preferred embodiments of the invention are disclosed herein, it is to be understood that the invention is not limited to the preferred embodiments and is to be interpreted by the appended claims.

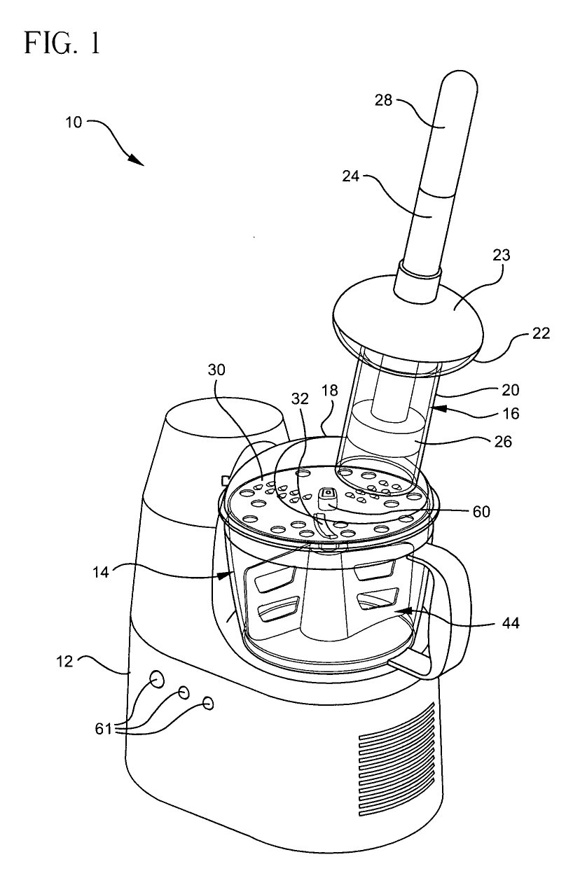

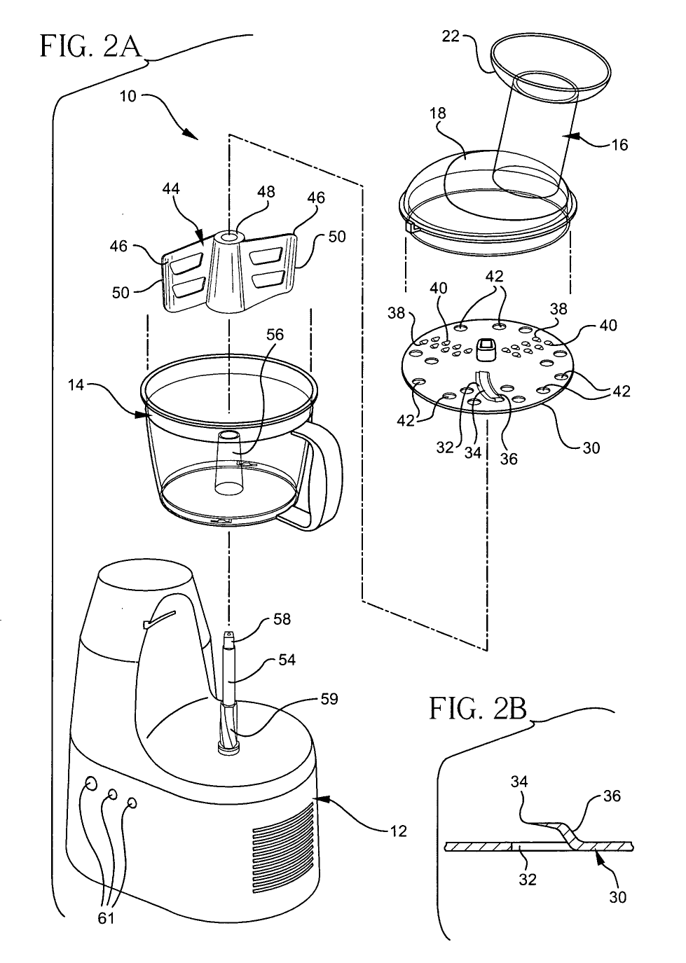

An apparatus 10 that may be used to produce desserts in accordance with the invention includes a base 12, a container 14 removably mounted to the base, and a feed vessel 16. The container 14 includes a removable cover 18 to which the bottom of the feed vessel 16 is attached. The feed vessel 16 is comprised of an elongate tube 20 having an open top end 22, a cover 23 and a bottom end that communicates with the space beneath the cover 18. A plunger assembly 24 is provided for use within the feed vessel. The plunger assembly includes a piston 26 and rod 28. FIGS. 1-3 provide views of the apparatus and components thereof. As discussed hereafter, food products are introduced into the apparatus through the open top end 22 of the feed vessel and urged downwardly by a user exerting pressure on the plunger assembly.

A cutting member in the form of a cutting blade 30 is positioned beneath the cover 18 of the container. Food products introduced into the feed vessel can be moved into engagement with the cutting blade 30. The disclosed cutting blade is designed to slice, grate and/or chop food products. One of the primary purposes of the apparatus is to process a combination of food products having different characteristics. The cutting blade's effect(s) on a particular food product will depend on the physical nature of the food product. As one of the food products intended to be processed by the cutting blade is a frozen food product such as ice cream or ice milk, the blade is designed to effect the slicing of such products. Other products, such as cookies and nuts, do not ordinarily lend themselves to slicing regardless of blade design. They will be reduced in size by more of a chopping or grating action than by slicing. The rate at which the blade and food products move with respect to each other is another important factor in the physical characteristics of the food products that are processed by the cutting blade.

The cutting blade 30 employed in the embodiment of the invention shown in the drawings is comprised of a circular metal disc having a plurality of openings and other elements capable of acting on food products in various ways. An elongate slot 32 extends radially outwardly from a point near the center of the disc and adjoins an elongate cutting edge 34. The edge 34 is provided on a projection 36 that extends above the slot 32. Two additional sets of openings 38 extend radially outwardly from the center of the disc. These openings are adjoined by raised portions 40 similar to those found in cheese graters. Circular openings 42 are provided near the outer edge of the disc as well as other locations. The edge 34 adjoining the slot 32 is capable of cutting food products. It will be appreciated that the particular arrangement of openings in the disc shown is not critical for the successful operation of the apparatus. The openings and cutting edge(s) may be different in shape and/or number. The apparatus may indeed be provided with several different cutting members, each having different configurations and/or different arrangements of slot(s) and/or opening(s), to allow the consumer to choose among them depending on which ingredients are to be employed.

A plastic mixing blade 44 is positioned within the container 14 beneath the cutting blade 30. It includes a pair of vanes 46 secured to a hub 48, forming a spiral-type arrangement. Each vane includes a pair of relatively large openings. The outer edge portion 50 of each vane is curved. The mixing blade can be removed for cleaning or replacement. It will be appreciated that mixing blades having constructions different from that shown and described can be employed so long as they can effectively blend food products in the mixing portion of the container. The outer edge portions of the mixing blade preferably substantially adjoin the container wall such that everything in the container is effectively blended. The construction of the mixing blade should be such that it can blend the products within the container without causing substantial changes in the food product(s) mixed with the frozen dessert product(s). For example, cookies and nuts reduced in size by the cutting edges of the cutting member are not to be substantially further reduced in size by the mixing blade, if reduced in size at all.

A low speed, high torque electric motor 52 is mounted within the base 12 of the apparatus. In order to make desserts having characteristics that are considered particularly desirable, the food products are preferably engaged by the cutting blade and mixing blades at relative speeds that promote such characteristics. A low speed, high torque motor for driving the cutting and mixing blades is effective for manufacturing desserts comprising frozen dessert food products and other food product(s) such as candy, nuts, or cookies. An electric motor capable of generating torque ranging between about 90-150 mNm when operating between maximum efficiency and maximum power output may be employed. The motor would operate at 120V and 60 Hz for use in the United States. Different operating parameters may be necessary if the apparatus is intended for use outside the United States. The cutting blade 30 is driven at a lower speed than the mixing blade 44 in the preferred embodiment. The motor is coupled by a gear assembly 53 to a rotatable drive rod 54 that extends from the base 12 and into the container 14. The container includes an upright tube 56 through which the drive rod extends. The outer wall of the hub 48 of the mixing blade is positioned over the tube 56. The drive rod extends through an opening in the top wall of the hub 48. It has a top end portion 58 that is substantially square in cross section. The cutting blade includes a hub 60 that defines a square opening for receiving the top end portion 58 of the drive rod 54. The hub 48 of the mixing blade 44 is coupled to the bottom portion 59 of the drive rod. The bottom portion of the drive rod and the inner surface of the inner hub wall are spliced or otherwise configured to mate with each other. Both the cutting and mixing blades are driven in the same direction. It will be understood, however, that it is not a requirement of the invention that the cutting blade be driven in the same direction as the mixing blade.

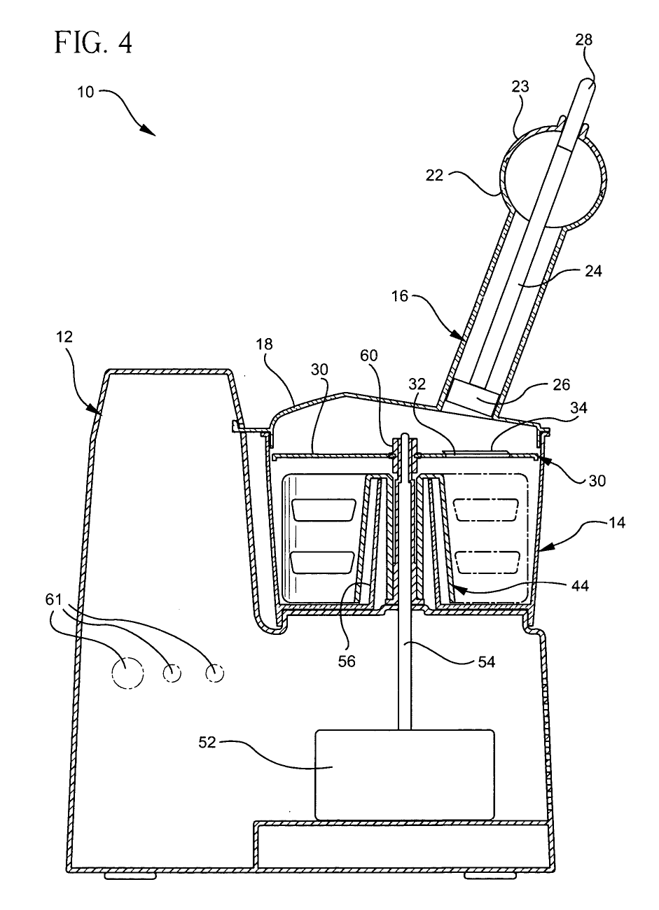

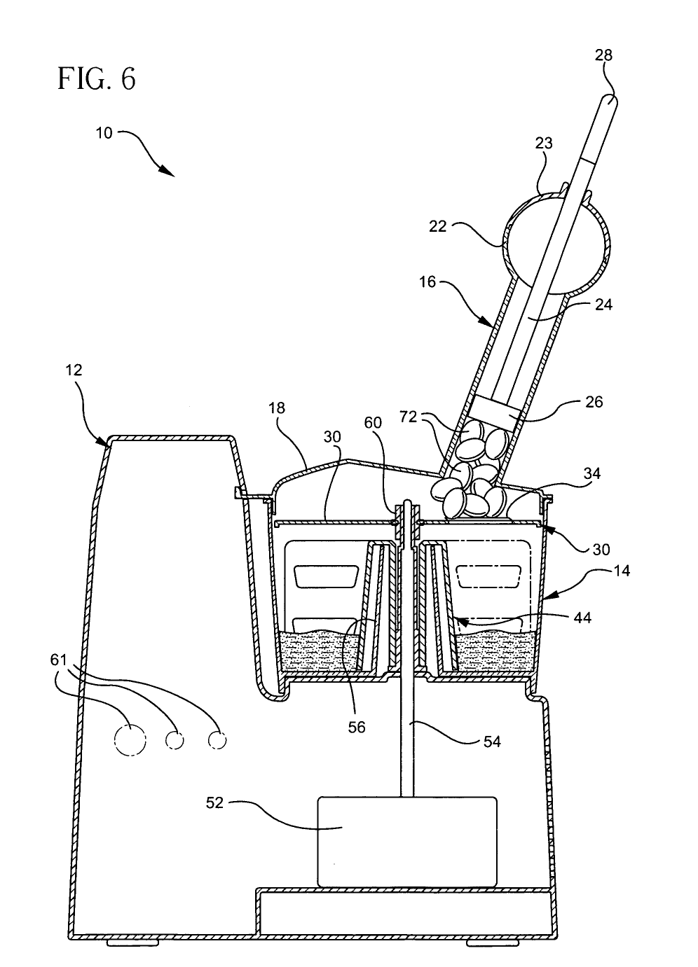

As both the cutting blade 30 and mixing blade 44 are coupled to the same drive rod 54 in the apparatus described above and shown in FIGS. 1-7, they are driven at the same speed. The apparatus is accordingly provided with controls 61 to allow the blades to rotate at a relatively low speed until the food products are all processed by the cutting blade. The blades are then rotated at a higher speed by pushing the appropriate control button to provide optimal blending of the products within the container.

The inner surface of the container cover 18 is preferably contoured so as to form a slope towards the cutting blade. This helps eliminate excess frozen dessert product from being trapped between the cover and blade.

The container 14, cover 18, mixing blade, cutting blade, and plunger assembly are preferably all separable items that can be washed in a dishwasher. The feed vessel 16 can be an integral part of the cover or separable therefrom.

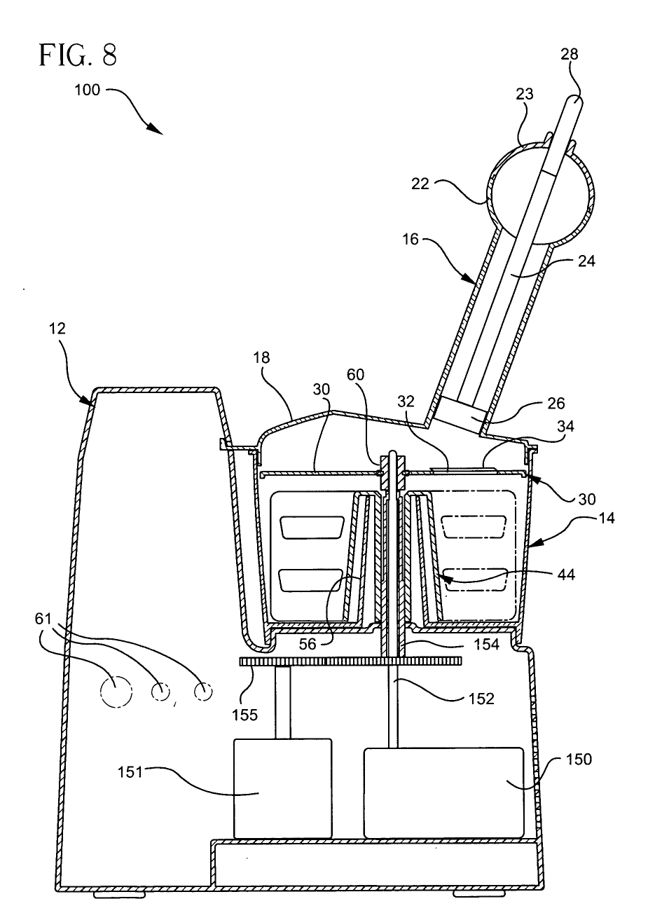

An alternative embodiment 100 of the invention including two electric motors 150, 151 is shown in FIG. 8. The same reference numerals are used to designate elements common to the embodiment of FIGS. 1-7. The cutting and mixing blades are mounted to concentric, independently rotatable drive rods 152, 154. Each motor is coupled to a drive rod by a gear assembly so that the drive rods will be rotated at desired speeds when the motors are actuated. One gear assembly 155 is shown schematically in FIG. 8 for coupling the output shaft of the motor 151 with the outer drive rod 154. The motor 150 is also coupled to the inner drive rod 152 by a gear assembly that is also designated by numeral 150 in FIG. 8.

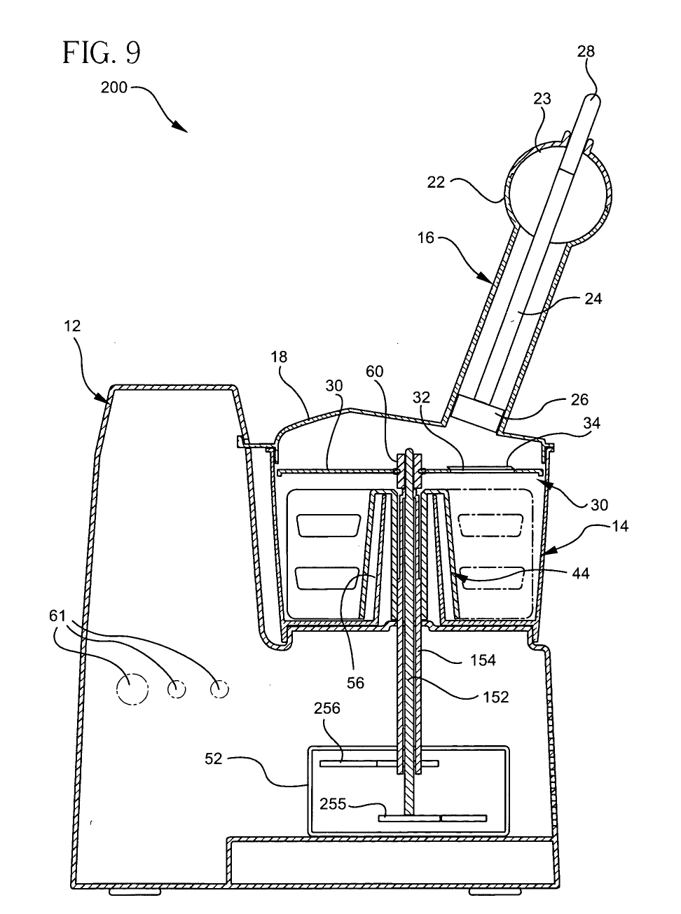

A single motor 52 is used for simultaneously driving the cutting blade 30 and mixing blade 44 at different speeds in the apparatus 200 according to the preferred embodiment of the invention. This embodiment is shown in FIG. 9. A first gear assembly 255 is connected between the motor and the drive rod associated with the cutting blade. A second gear assembly 256 operatively couples the motor and the drive rod for the mixing blade. The cutting and mixing blades are mounted to independently rotatable drive rods 142, 154 in this embodiment, and are preferably operable simultaneously.

While the apparatus according to the invention may be employed to make a variety of food products, possibly including some that would not be characterized as dessert products, it is intended to be used primarily as a dessert maker in which a frozen dairy or non-dairy dessert product is combined with a non-frozen food product. It is further intended to produce a blended dessert product where the food product(s) combined with the frozen dessert product are reduced in size by the cutting blade without becoming so finely chopped or shredded that its original texture is completely lost. The frozen dessert products to be processed will mostly likely be frozen dairy products such as ice cream, ice milk, or frozen yogurt. Frozen non-dairy dessert products such as soy “ice cream” may alternatively be employed, as well as combinations of frozen dessert products. It is also likely that the frozen dessert product will be retrieved from the user's freezer and be relatively hard when deposited in the feed vessel. This type of dessert product, when subjected to one or more cutting edges in a cutting member, will be progressively sliced by the cutting edges adjoining the openings(s) in the blade. The sliced pieces fall by gravity into the mixing portion of the container as they pass through the cutting member openings(s).

The food product(s) to be combined with the frozen dessert product will, in most cases, be of a different texture than the frozen desert product. Food products such as cookies and nuts will tend to be chopped or grated as opposed to sliced when subjected to processing by the cutting blade. Some candy products may be sliced by the cutting edge(s) of the cutting blade while others may tend to be grated. The speed at which the combined food products and cutting blade move with respect to each other is a factor in determining the physical characteristics of the food products that are introduced into the mixing portion of the container for blending. High speed processing tends to result in a softer and perhaps mushy frozen dessert product. Harder products such as cookies and nuts will be ground into much smaller pieces. Lower speed processing also causes frozen dessert products such as ice cream to be softened, though they will not tend to become mushy. Harder food products are chopped or ground into larger pieces, and will fall into the mixing portion of the container largely as chunks as opposed to a more finely granulated substance. A blended dessert product comprising a soft, but not mushy frozen dessert product(s) and chunks or slices of a harder, typically non-frozen food product is ordinarily what is desired when the apparatus is employed, though some individuals may prefer desserts having other characteristics. The apparatus is accordingly designed to at least allow production of the desired product, though it may enable the production of other dessert products as well.

The low speed, high torque electric motor allows the rotation of the cutting blade at speeds of about 580-680 rpm that will cause hard ice cream and the like to be sliced without turning mushy and hard food products to largely be broken, coarsely grated or cut into chunks or slices or the like rather than mostly granulated. The mixing blade is also rotated at a speed at which the food products therein are blended to form a dessert product having the consistency of soft ice cream blended with chunks or slices of one or more different food products. The speed of the mixing blade can be about 1000-1400 rpm when the apparatus is used to make such a dessert product.

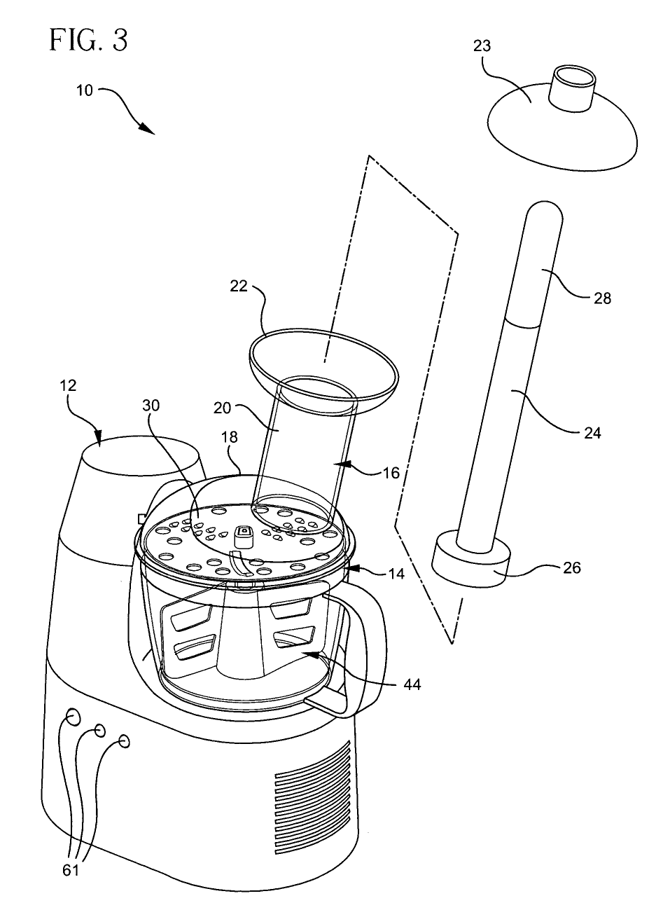

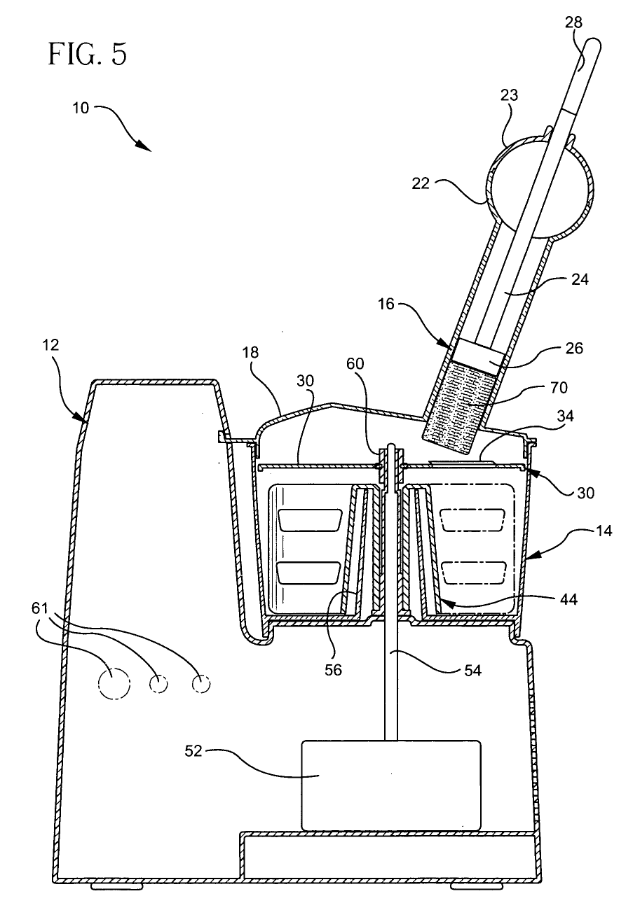

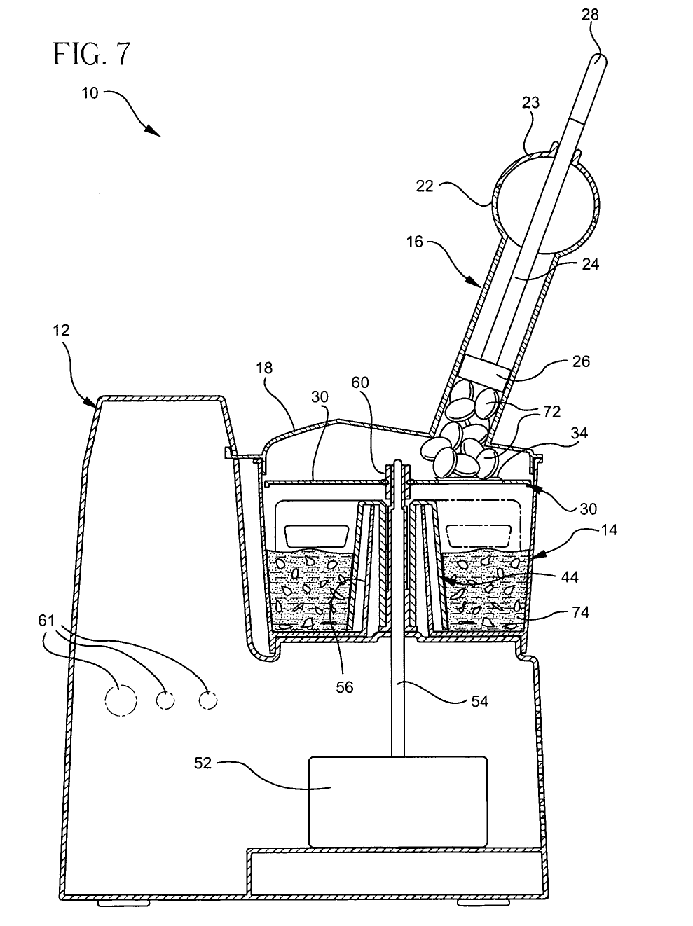

The apparatus 10 can be employed in the following manner to produce a blended dessert product with desirable characteristics. The plunger assembly 24 and cover 23 are removed from the feed vessel 16, as shown in FIG. 3. A frozen dessert product 70 such as ice cream is deposited within the feed vessel. A relatively hard food product 72 such as cookies, candy or nuts may then be placed in the vessel. Alternatively, as shown in FIG. 5, the cover and plunger assembly may be replaced and the frozen dessert product urged into the container 14, as shown in FIG. 5 while the cutting blade is rotated at a selected aped. The different types of food products may be deposited in one or more layers. It is unnecessary to mix the products or to reduce the size of the relatively hard products in the feed vessel, though it may be necessary to break a relatively large cookie or candy bar into smaller pieces so that it will fit within the feed vessel. Following introduction of the frozen dessert product, the cover and plunger assembly can again be removed for insertion of the hard food product 72 into the feed vessel. The plunger assembly is then reassembled to the feed vessel and the electric motor again actuated. As the cutting and mixing blades rotate about their axes, the user urges the food products toward the cutting blade by exerting downward force on the plunger assembly. (This step could alternatively be performed by gravity or automatically as opposed to manually). The cutting blade slices, grates, chops or otherwise reduces the sizes of the food products. These products pass through the slot(s) and opening(s) in the blade and fall into the mixing portion of the container. The cutting blade has cutting edge(s) and opening(s) which cause the relatively hard food products to pass therethrough in slices or chunks that substantially retain the taste and texture of the food products originally deposited in the feed vessel. Rotation of the cutting blade is at a speed (for example, about 680 rpm) that does not cause substantial melting of the food products or granulation thereof into particles of undesirable small size. As the cutting blade does not effect substantial blending of the food products, such blending is accomplished by rotation of the mixing blade within the container. The mixing blade blends the food products at a relatively slow speed that is, for purposes of this example, about 1340 rpm. The resulting product 74, shown in FIG. 7, has substantially the consistency of a soft ice cream having discernable chunks or slices of one or more added ingredients such as cookies, candy, fruit and/or nuts blended throughout.

One blending is completed, the feed vessel 16, cover 18 and cutting blade 30 are removed to provide access to the container. The contents of the container can be scooped out while the container remains on the base 12 or after it is moved to another location.

The method and apparatus can be used to process frozen ice cream or ice milk combined with other food products such as candy containing a mixture of caramel, nuts and chocolate, cream filled sandwich cookies, or fresh fruit. A smooth textured dessert that is thick enough to eat with a spoon can be produced. If desired, a product having the general consistency of a milk shake can be produced if milk is first added to the mixing container. As milk shakes are preferably consumable with a straw, certain ingredients would not ordinarily be combined with the ice cream that would impede the use of a straw.

1. An apparatus for producing dessert products, comprising:
a base;
an electric motor mounted to said base;
a container removably mounted to said base, said container having an outer surface and an inner surface;
a cutting member having an opening and a cutting edge adjoining said opening;
a feed vessel for receiving food products, said cutting member being positioned to engage food products introduced into said feed vessel, said container being positioned to receive food products from said feed vessel after they engage said cutting member and pass through said opening; and
a mixing blade in said container for blending food products and including an edge portion substantially adjoining said inner surface of said container, said electric motor being coupled to said mixing blade.

2. An apparatus as described in claim 1 wherein said container includes an interior surface shaped to direct products within said container towards said cutting member.

3. An apparatus as described in claim 1, wherein said electric motor is a low speed, high torque motor.

4. An apparatus as described in claim 1 including means for urging products in said feed vessel towards said cutting member.

5. An apparatus as described in claim 1 including a drive member operatively associated with said electric motor for causing relative movement between food products and said cutting member.

6. An apparatus as described in claim 5 wherein said cutting member is engaged to said drive member and rotatable therewith.

7. An apparatus as described in claim 1, wherein said mixing blade is coupled to said electric motor by a gear assembly such that said mixing blade can be rotated at a speed between about 1000-1400 rpm.

8. An apparatus as described in claim 1, wherein said opening is an elongate slot.

9. An apparatus for producing dessert products, comprising:
a feed vessel for receiving food products;
a container positioned beneath said feed vessel;
means for slicing food products from said feed vessel and dropping them into said container;
a mixing blade in said container for blending food products therein; and
a low speed, high torque electric motor coupled to said mixing blade.

10. An apparatus as described in claim 9 wherein said means for slicing food products and dropping them into said container comprise a cutting member having a cutting edge and an opening adjoining said cutting edge.

11. An apparatus as described in claim 10 wherein said opening is an elongate slot.

12. An apparatus as described in claim 10, wherein said mixing blade extends substantially to an inner surface of said container.

13. An apparatus as described in claim 12 wherein said motor is operatively coupled to said means for slicing and dropping.

14. An apparatus as described in claim 9 including a base, said container being removably mounted to said base, said motor being within said base, and a gearing assembly coupled between said motor and said mixing blade for limiting the speed of said mixing blade to about 1400 rpm or less.

15. A method for producing a soft, at least partially frozen dessert product, comprising:
feeding a frozen food product and a second food product to a cutting member having a cutting edge;
causing said frozen and second food products to be moved with respect to said cutting edge at a selected speed such that said frozen food product is sliced and said second food product is cut into slices and/or chunks;
causing said food products to drop into a container following being sliced and cut, and
blending said food products within said container such that a blended dessert product is formed with the frozen food product having substantially the consistency of soft ice cream and the second food product is in the form of chunks and/or slices.

16. A method as described in claim 15 including blending said food products in said container by rotating a mixing blade within said container.

17. A method as described in claim 16, wherein said mixing blade is rotated at a speed of about 1400 rpm or less.

18. A method as described in claim 17, wherein said speed is between about 1000-1400 rpm.

19. A method as described in claim 15 wherein said frozen food product and said second food product have different textures, including causing said frozen food product to be sliced by a cutting member including said cutting edge and to fall through an opening in said cutting member into said container upon being sliced.

20. A method as described in claim 19 wherein said cutting edge and said opening are elongate.

21. A method as described in claim 20 wherein said frozen food product is selected from the group consisting of frozen dairy products and frozen non-dairy dessert products and said second food product is selected from the group consisting of cookies, candy, fruit, nuts and combinations thereof.

22. A method as described in claim 15, including blending said product by rotating a mixing blade in said container, said mixing blade having an edge portion substantially adjoining an inner surface of said container.
